(19) United States
(12) Patent Application Publication
(10) Pub. No.: US 2009/0221190 A1
(43) Pub. Date: Sep. 3, 2009

(54) Electric connector housing

(75) Inventors: Tsugio Ambo, Tokyo (JP); Yukifumi Machida, Tokyo (JP); Yoshikazu Tanaka, Tokyo (JP); Michiyasu Watanabe, Tokyo (JP); Tetsu Hirose, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Mitsubishi Cable Industries, LTD., Tokyo (JP)

(21) Appl. No.: 11/921,601

(22) PCT Filed: Jun. 5, 2006
(86) PCT No.: PCT/JP2006/311253

§ 371 Date: Mar. 26, 2009

(30) Foreign Application Priority Data
Jun. 6, 2005 (JP) 2005-165851

(51) Int. Cl. H01R 13/514

(52) U.S. Cl. 439/701

(57) ABSTRACT

An electric connector housing that is, even though small in size, capable of fixing a connection terminal with large engagement force. An upper cover (22) is placed on a holder (21) where a connection terminal (11) is fixed, and the holder (21) and the upper cover (22) are connected by a locking mechanism. In this state, the holder (21) and the upper cover (22) firmly prevent the connection terminal (11) from moving in a front-rear direction and a top-bottom direction. The connector housing cooperates with a mating connector to cause connector terminals to be fitted together, and functions as a connector.

### TECHNICAL FIELD

The present invention relates to an electric connector housing for accommodating therein connection terminals of small size.

### TECHNICAL BACKGROUND

For instance, connection terminals for use in an electrical circuits of automobiles have become smaller and smaller.

In general, connection terminals installed within an electric connector housing are retained therein by means of resilient stopping lances provided within the electric connector housing.

### DISCLOSURE OF THE INVENTION

### Problems to be solved by the Invention

In accordance with a miniaturization of connection terminals, it is difficult to form stopping lances within the electric connector housing by injection mold. Known stopping lances could have a small engaging force.

In order to mitigate this problem, in a following Japanese Patent Document 1 there is disclosed a known electric connector housing, in which a rear holder 1 having formed therein stopping lances 2 is fitted to a rear portion of a housing as shown in FIG. 43.

However, even in such a structure, it is still difficult to form stopping lances of small size, and a sufficiently large engaging force for retaining the connection terminals within the housing.

Patent Document 1: Japanese Patent Kokai 2004-39535

The present invention has for its object to provide an electric connector housing, in which the above mentioned drawbacks of the known electric connector housings can be removed and connection terminals of small size can be fixed in position with a large engaging force.

### Means of Solving the Problems

In order to attain the above object, according to the invention, an electric connector housing comprises an assembly of a holder having a plurality of grooves for accommodating therein respective connection terminals and a cover for covering said grooves of the holder, wherein moving preventing means for preventing said connection terminals from moving in forward and backward directions are provided in either one or both of said holder and cover.

### MERITS OF THE INVENTION

In the electric connector housing according to the invention, even though a size of the connection terminals becomes small, the connection terminals can be retained within the housing with a sufficiently large retaining force.

### BRIEF DESCRIPTION OF THE DRAWINGS

FIG. 1 is a plan view showing a connection terminal;

FIG. 2 is a longitudinal cross sectional view cut a portion of the connection terminal;

FIG. 3 is a lateral cross sectional view cut along a line A-A in FIG. 2;

FIG. 4 is a plan view illustrating a first embodiment 1 of the electric connector housing according to the invention;

FIG. 5 is a front view of the electric connector housing of the first embodiment 1;

FIG. 6 is a longitudinal cross sectional view depicting condition in which a connection terminal is installed in the housing;

FIG. 7 is a plan view representing a holder;

FIG. 8 is a lateral cross sectional view cut along a line B-B in FIG. 7;

FIG. 9 is a longitudinal cross sectional view illustrating the holder;

FIG. 10 is a lateral cross sectional view showing a condition in which the connection terminal is fit within the holder;

FIG. 11 is a longitudinal cross sectional view of the holder having the connection terminal installed therein;

FIG. 12 is a bottom view depicting an upper cover;

FIG. 13 is a longitudinal cross sectional view of the cover;

FIG. 14 is a front view illustrating a second embodiment 2 of the electric connector housing according to the invention;

FIG. 15 is a longitudinal cross sectional view depicting a condition in which a connection terminal is installed within the housing;

FIG. 16 is a longitudinal cross sectional view showing an intermediate holder;

FIG. 17 is an explanatory view representing an assembling step;

FIG. 18 is a front view depicting a third embodiment 3 of the electric connector housing according to the present invention;

FIG. 19 is a longitudinal cross sectional view showing the electric connector housing of the third embodiment 3;

FIG. 20 is a lateral cross sectional view showing an intermediate holder;

FIG. 21 is a longitudinal cross sectional view of the intermediate holder;

FIG. 22 is a longitudinal cross sectional view illustrating a lower cover;

FIG. 23 is a plan view depicting a fourth embodiment 4 of the electric connector housing according to the invention;

FIG. 24 is a front view of the electric connector housing of the fourth embodiment 4;

FIG. 25 is a longitudinal cross sectional view of the electric connector housing;

FIG. 26 is a bottom view showing an upper intermediate cover;

FIG. 27 is a longitudinal cross sectional view of the upper intermediate cover;

FIG. 28 is a front view illustrating an outer cover;

FIG. 29 is a longitudinal cross sectional view of the outer cover;

FIG. 30 is a longitudinal cross sectional view showing an assembling step;

FIG. 31 is a front view depicting a fifth embodiment 5 of the electric connector housing according to the invention;

FIG. 32 is a longitudinal cross sectional view of the electric connector housing of the embodiment 5;

FIG. 33 is a front view showing an outer cover;

FIG. 34 is a longitudinal cross sectional view of the outer cover;

FIG. 35 is a longitudinal cross sectional view depicting an assembling step;

FIG. 36 is a front view showing a sixth embodiment 6 of the electric connector housing according to the invention;

FIG. 37 is a longitudinal cross sectional view of the electric connector housing of the sixth embodiment 6;

FIG. 38 is a bottom view depicting an intermediate holder;

FIG. 39 is a longitudinal cross sectional view of the intermediate holder;

FIG. 40 is a front view depicting an outer cover;

FIG. 41 is a longitudinal cross sectional view of the outer cover;

FIG. 42 is a longitudinal cross sectional view showing an assembling step; and

FIG. 43 is a perspective view illustrating a known electric connector housing.

### EXPLANATION OF THE REFERENCE NUMERALS

11 connection terminal
12 contact portion
13 intermediate portion
14 clamp portion
15 electric wire
16 cut-out portion
21 holder
22 upper cover
31, 41, 71 intermediate holder
42 lower cover
51 intermediate upper cover
52, 61, 72 outer cover

### BEST MODE OF THE INVENTION

Now the present invention will be explained in detail with reference to the embodiments of the invention shown in the drawings.

### Embodiment 1

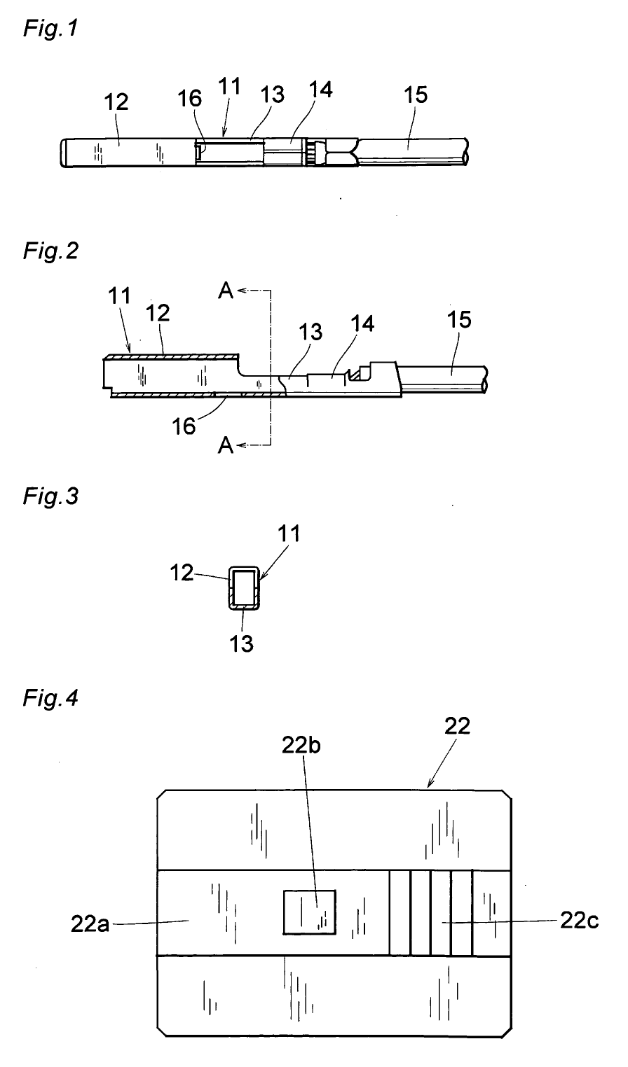

FIG. 1 is a plan view showing a connection terminal to be used, FIG. 2 is a longitudinal cross sectional view illustrating the connection terminal a part of which is cut out, and FIG. 3 is a lateral cross sectional view cut along a line A-A in FIG. 1. At a front end of a connection terminal 11 there is provided a contact portion 12 having a rectangular tube shape, and at a rear portion continued from the front portion through an intermediate portion 13 an electric wire 15 is connected by means of a clamp portion 14. Furthermore, in a bottom portion of the contact portion 12, there is formed a cut-out portion 16.

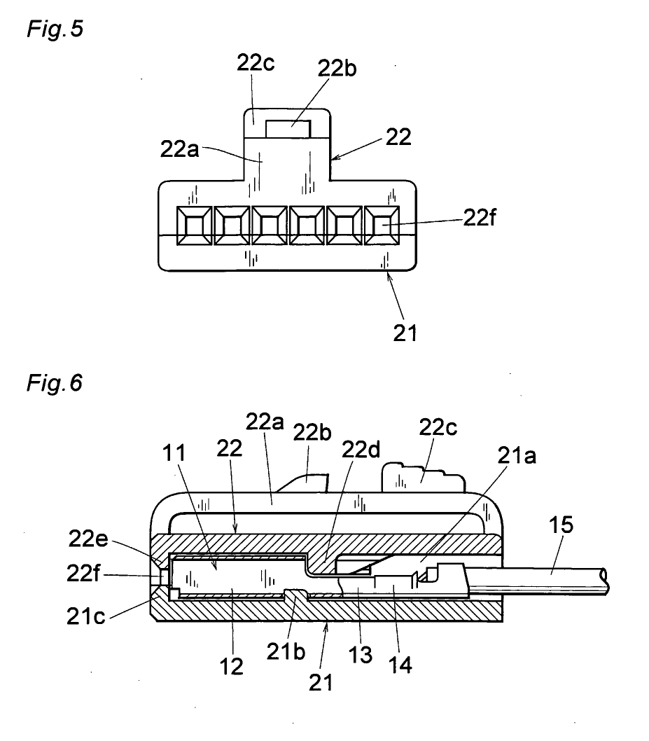

FIG. 4 is a plan view showing the electric connector housing of the first embodiment 1, FIG. 5 is a front view thereof and FIG. 6 is a longitudinal cross sectional view showing a condition in which the connection terminal 11 is installed within the electric connector housing. The electric connector housing is composed of an assembly of a lower holder 21 and an upper cover 22 provided on the lower holder. The connection terminals 11 are fit into respective grooves 21a formed in an upper surface of the holder 21. The upper cover 22 is arranged on the holder 21 in such a fashion that the grooves 21a are covered with the upper cover 22. On an upper surface of the upper cover 22 there are provided a resilient bridge portion 22a which functions to lock a cooperating electric connector housing to the relevant electric connector housing, a locking projection 22b and a push portion 22c for disengaging the locking between the relevant electric connector housing and the cooperating electric connector housing.

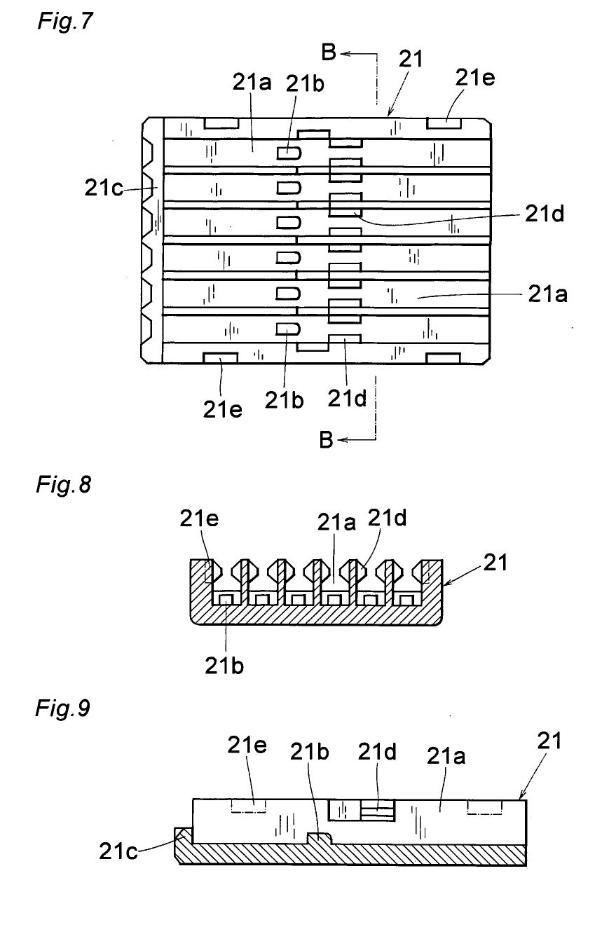

FIG. 7 is a plan view showing the holder 21, FIG. 8 is a lateral cross sectional view cut along a line B-B in FIG. 7 and FIG. 9 is a longitudinal cross sectional view depicting the holder 21. In an upper surface of the holder 21, there are formed a plurality of the grooves 21a extending in the longitudinal direction, and in the bottom surface of each groove 21a there is formed an engaging protrusion 21b which is inserted into the cut-out portion 16 of the connection terminal 11. Furthermore, a front wall portion 21c is provided at a front end portion of the grooves 21a, said front wall portion serving to prevent undesired forward movement of the connection terminals 11 and to guide cooperating connection terminals into the grooves 21a. At both sides of a middle portion of each of the grooves 21a there are provided projections 21d which are engaged with the intermediate portion 13 of the connection terminal 11 to prevent undesired up and down movement of the connection terminals 11 within the grooves 21a. At four corners of the holder 21 there are further formed locking depressions 21e.

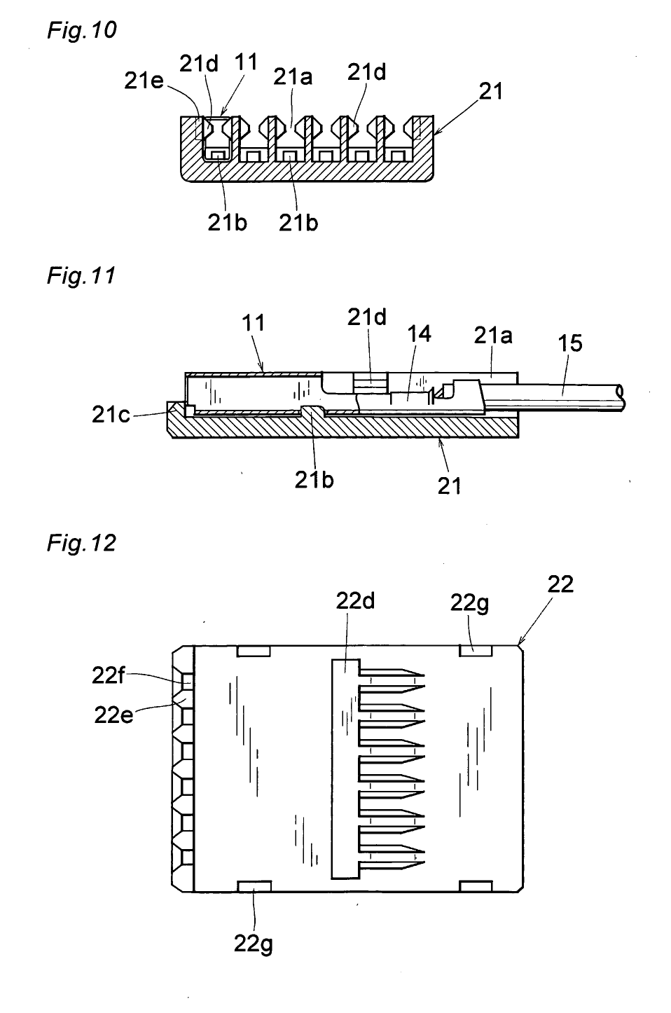

FIG. 10 is a lateral cross sectional view and FIG. 11 is a longitudinal cross sectional view showing a condition in which the connection terminal 11 is installed in the holder 21. Any undesired forward movement of the connection terminal 11 is prevented by the engaging protrusion 21b and front wall portion 21c. Any undesired up and down movement of the connection terminal 11 is prevented by the projections 21d.

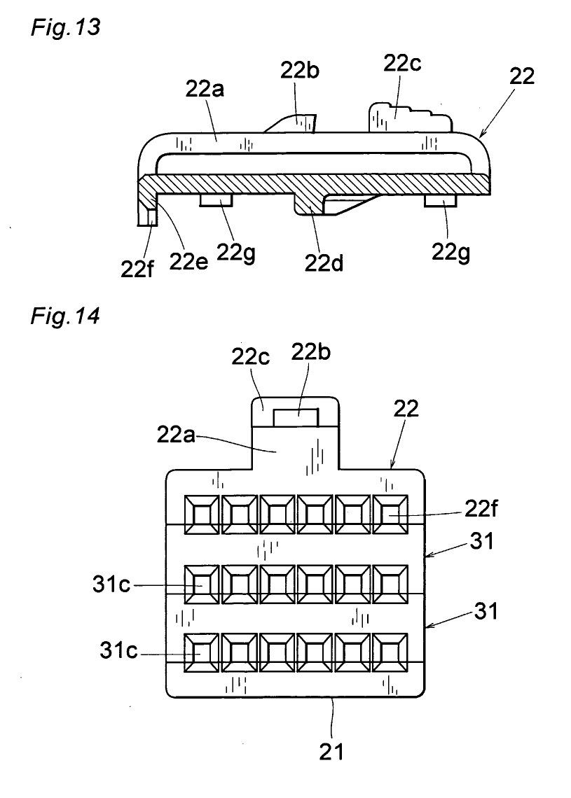

FIG. 12 is a bottom view and FIG. 13 is a longitudinal cross sectional view showing the upper cover 22. A plan view of the upper cover 22 is identical with that shown in FIG. 4. The upper cover 22 has formed therein a common engaging projection 22d which is engaged with the rear ends of the contact portions 12 of the connection terminals 11 to prevent undesired backward movement of the connection terminals. In a front wall portion 22e of the upper cover 22 there are formed guide openings 22f for receiving cooperating connection terminals 11. Moreover, at four corners of the upper cover 22 there are formed locking claws 22g which are engaged with the locking depressions 21e of the holder 21.

As illustrated in FIGS. 10 and 11, after installing the connection terminals 11 within the holder 21, the upper cover 22 is placed on the holder 21 and the locking claws 22g are clicked into the locking depressions 21e. Then, the holder 21 and upper cover 22 are coupled with each other as shown in FIGS. 5 and 6.

In this condition, the connection terminal 11 can be firmly prevented from moving in the forward direction as well as in the up and down direction by means of the holder 21 and upper cover 22. The thus assembled electric connector housing may be combined with a cooperating electric connector housing to constitute an electric connector.

### Embodiment 2

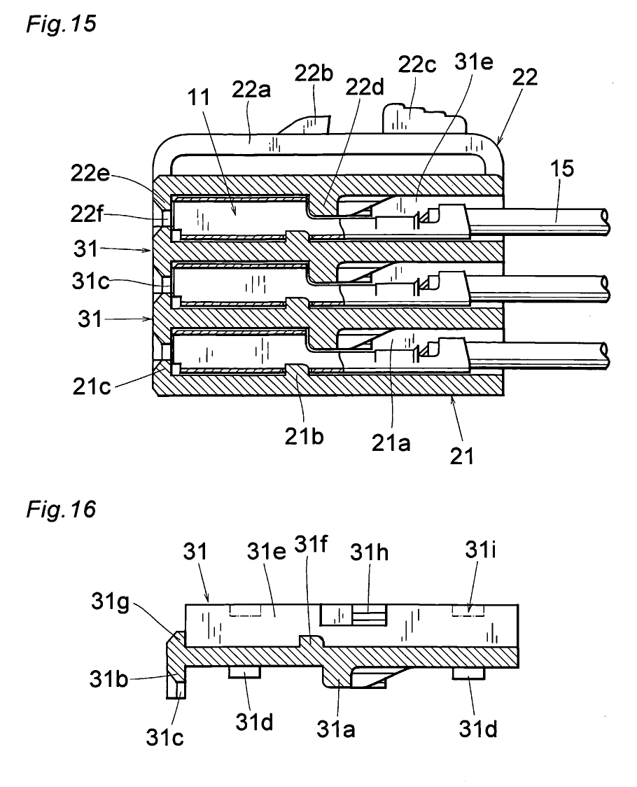

FIG. 14 is a front view showing the second embodiment 2 of the electric connector housing according to the invention and FIG. 15 is a longitudinal cross sectional view depicting a condition in which a connection terminal 11 is installed within the housing. A plan view of the housing of this embodiment is identical with that shown in FIG. 4. In this embodiment 2, connection terminal accommodating portions each of which is similar to that of the first embodiment 1 are placed one on the other. On a holder 21 which is identical with the holder 21 of the first embodiment 1, two intermediate holders 31 are stacked, and on the upper intermediate holder 31 is placed an upper cover 22 which is identical with the upper cover 22 of the first embodiment 1. The connection terminals 11 are installed in the holder 21 and two intermediate holders 31.

FIG. 16 is a longitudinal cross sectional view illustrating the intermediate holder 31. A plan view of this intermediate holder 31 is identical with the plan view of the holder 21 shown in FIG. 7, and a bottom view of the intermediate holder 31 is identical with the bottom view of the upper cover 22 shown in FIG. 12. On the bottom surface of the intermediate holder 31 there are provided an engaging projection 31a, a front wall portion 31b, guide openings 31c and locking claws 31d at four corners. On the top surface of the intermediate holder 31 there are provided grooves 31e, engaging protrusions 31f for preventing the forward movement of the connection terminals, a front wall portion 31g, projections 31h for preventing the up and down movement of the connection terminals and locking depressions 31i at four corners.

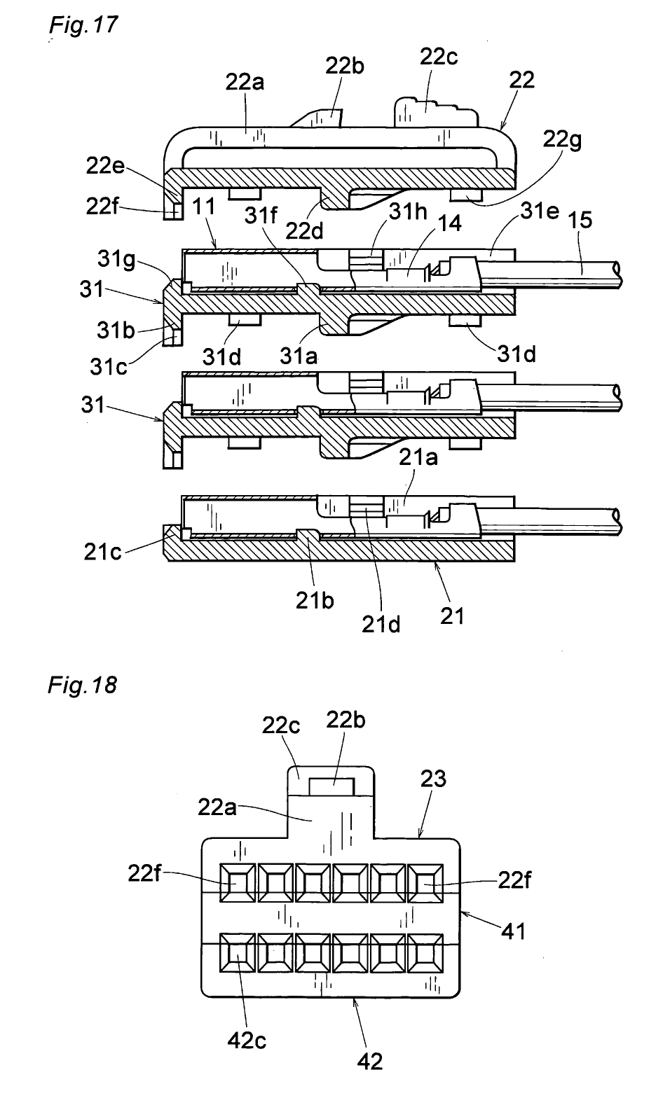

As depicted in FIG. 17, in the second embodiment 2, the connection terminals 11 are installed in the grooves 21a of the holder 21 such that the connection terminals 11 are held in position by means of the engaging protrusions 21b, engaging projections 21d and front wall portion 21c. Then, the intermediate holders 31 in which the connection terminals 11 are installed in position are successively stacked on the holder 21, while the locking claws 31d of the lower intermediate holder 31 are inserted into the locking depressions 21e of the holder 21 and the locking claws 31i of the upper intermediate holder 31 are clicked into the locking depressions 31i of the lower intermediate holder 31.

Next, the upper cover 22 is placed on the upper intermediate holder 31, while the locking claws 22g of the upper cover 22 are clicked into the locking depressions 31i of the upper intermediated holder 31 to fix the connection terminals 11 in position by means of the engaging projection 22d of the upper cover 22.

In this manner, all the connection terminals 11 installed within the holder 21 and two intermediate holders 31 can be fixed in position and the connection terminals 11 are effectively prevented from moving in the forward and backward direction as well as in the up and down direction.

### Embodiment 3

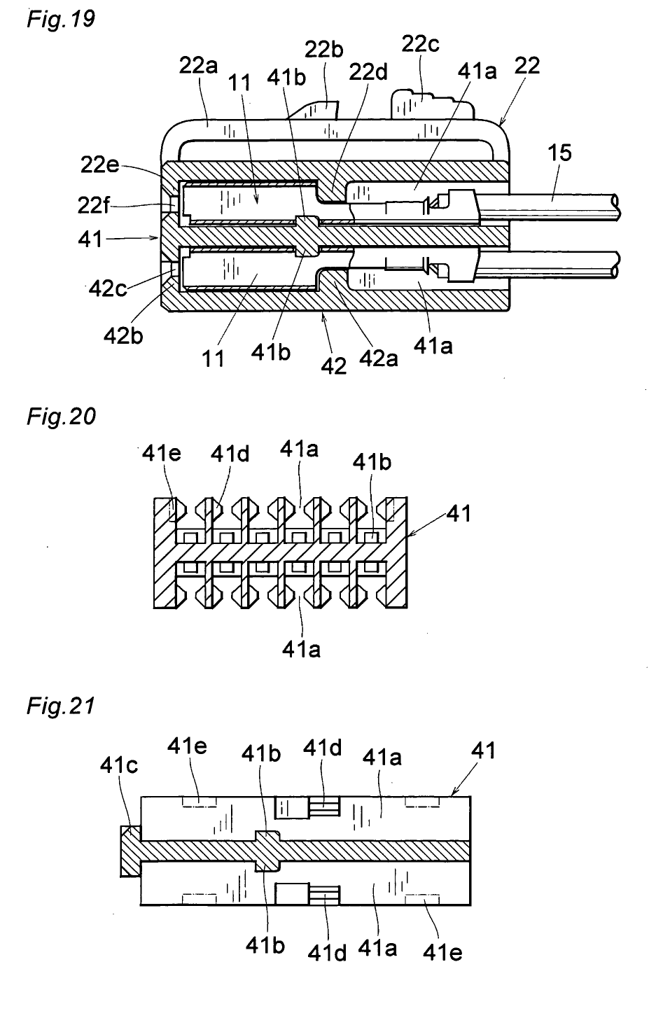

FIG. 18 is a front view and FIG. 19 is a longitudinal cross sectional view showing the electric connector housing of the third embodiment 3. A plan view of the electric connector housing of this embodiment 3 is identical with that shown in FIG. 4. On an upper surface of an intermediate holder 41 is placed an upper cover 22 and on a lower surface of the intermediate holder 41 is placed a lower cover 42.

FIGS. 20 and 21 are a lateral cross sectional view and a longitudinal cross sectional view illustrating the intermediate holder 41. A plan view and a bottom view of this intermediate holder 41 are identical with that shown in FIG. 7. That is to say, the upper and lower surfaces of the intermediate holder 41 have a symmetrical configuration. On each of the upper and lower surfaces of the intermediate holder 41, there are formed a plurality of longitudinal grooves 41a, engaging protrusions 41b, a front wall portion 41c, projections 41d for restricting the forward movement of the connection terminals, and four locking recesses 41e at four corners like as the holder 21. The connection terminals 11 are arranged in the grooves 41a formed in the upper and lower surfaces of the intermediate holder 41, said connection terminals being aligned symmetrically viewed in the up and down direction.

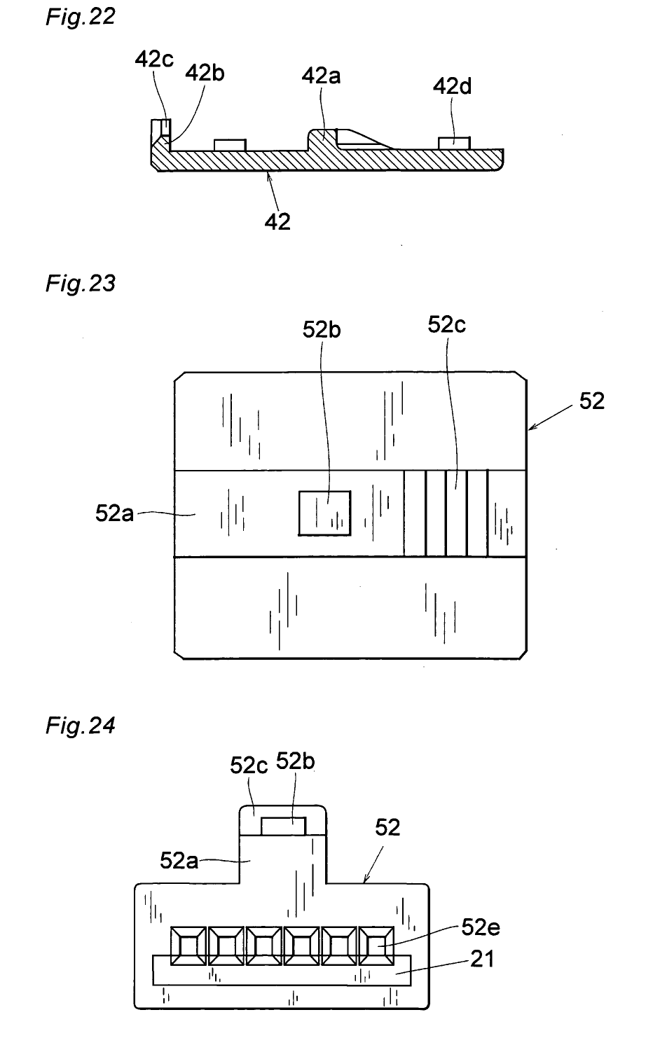

FIG. 22 is a longitudinal cross sectional view depicting the lower cover 42. A plan view of the lower cover 42 is identical with that shown in FIG. 12. The lower cover 42 has a substantially identical structure with that of the of the upper cover 22 from which the resilient bridge portion 22a is removed. The lower cover 42 has formed therein an engaging projection 42a, a front wall portion 42b, guide openings 42c and locking claws 42d.

After installing the connection terminals 11 within the intermediate holder 41, the lower and upper surfaces of the intermediate holder are covered with the lower cover 42 and upper cover 22, respectively, and locking claws are clicked into the locking recesses to assemble these three parts.

In this condition, undesired forward movement of the connection terminals 11 is prevented by the intermediate holder 41 and undesired backward movement of the connection terminals 11 is prevented by the upper and lower covers 22 and 42.

### Embodiment 4

FIGS. 23, 24 and 25 are a plan view, a front view and a longitudinal cross sectional view, respectively showing the electric connector housing of the present embodiment 4. A plurality of connection terminals 11 are installed in a plurality of grooves 21a of a holder 21 which is similar to that of the first embodiment 1. The grooves 21a are covered with an intermediate upper cover 51. An assembly of the holder 21 and intermediate upper cover 51 is covered with an outer cover 52. It should be noted that a front wall portion 21c has no guide opening as compared with the holder 21 of the first embodiment 1.

FIGS. 26 and 27 are a bottom view and a longitudinal cross sectional view, respectively illustrating the intermediate upper cover 51. On the bottom surface of the intermediate upper cover 51 there are formed an engaging projection 51a and four locking claws 51b at four corners, said locking claws 51b being clicked into four locking recesses 21e formed in the holder 21.

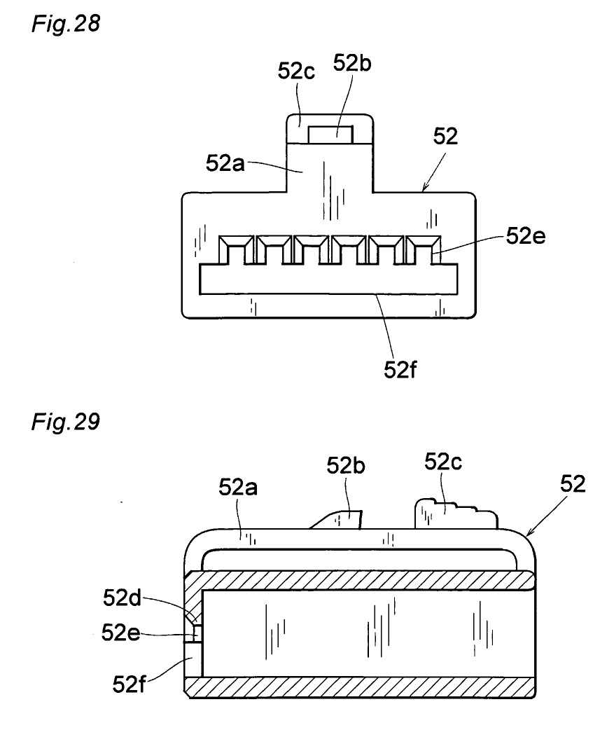

FIGS. 28 and 29 are a front view and a longitudinal cross sectional view, respectively showing the outer cover 52. A plan view of the outer cover 52 is identical with that shown in FIG. 23. The outer cover 52 has a vacant space, and a resilient bridge portion 52a, locking projection 52b and a push portion 52c are formed on an upper surface. A front wall portion 52d of the outer cover 52 has formed therein guide openings 52e and a fitting hole 52f into which a front end of the holder 21 is inserted.

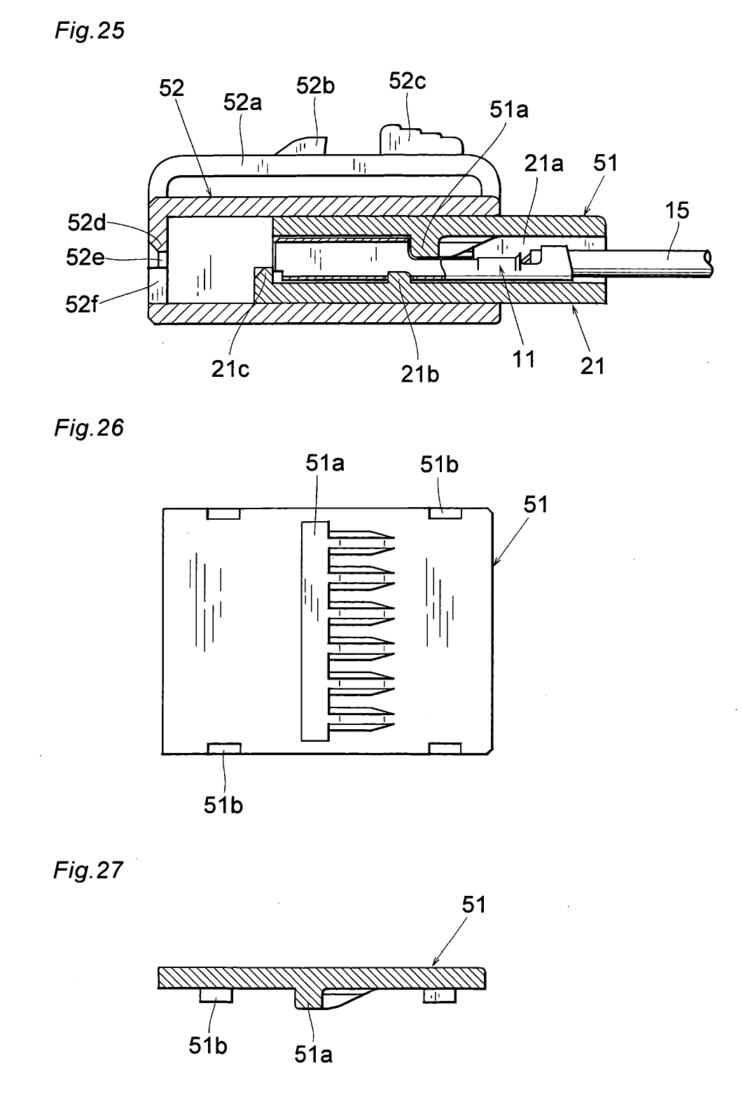

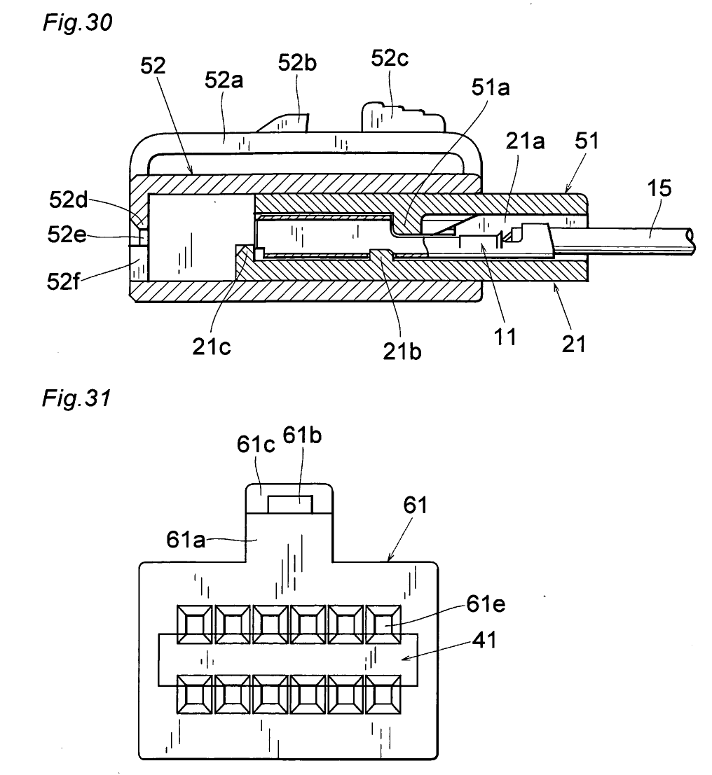

After placing the connection terminals 11 on the upper surface of the holder 21, the holder 21 is covered with the intermediate upper cover 51. Then, an assembly of the holder 21 and intermediate upper cover 51 is inserted into the outer cover 52 as depicted in FIG. 30 to obtain the electric connector housing shown in FIG. 25. Although not shown in the drawings, locking members for locking the holder 21 and intermediate upper cover 51 with the outer cover 52 are provided on an inner surface of the outer cover 52.

In this condition, the connection terminals 11 are prevented from moving in forward and backward direction by means of the holder 21 and at the same time the backward movement of the connection terminals 11 is inhibited by the intermediate upper cover 51. In the embodiment 4, since the outer cover 52 is provided, a much stronger structure can be realized as compared with the embodiments 1-3.

### Embodiment 5

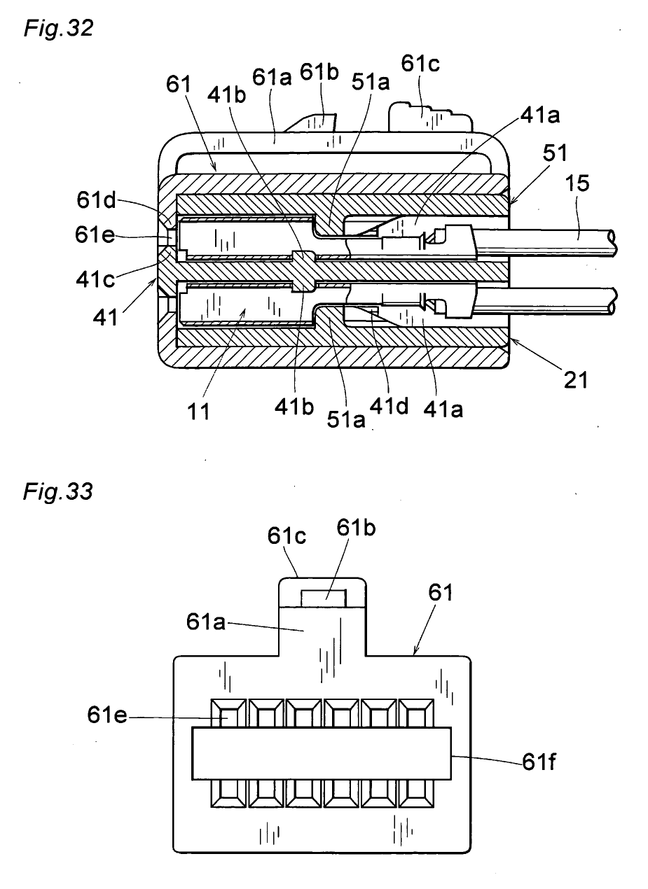

FIGS. 31 and 32 are a front view and a longitudinal cross sectional view, respectively illustrating the electric connector housing of the embodiment 5. A plan view of the electric connector housing of this embodiment 5 is identical with that shown in FIG. 23. A plurality of connection terminals 11 are installed in a plurality of upper and lower grooves 41a of an intermediate holder 41 which is similar to that of the embodiment 3. The upper and lower grooves 41a are covered with an intermediate upper cover 51 in the embodiment 4. Furthermore an assembly of the intermediate holder 41 and intermediate upper cover 51 is covered with an outer cover 61.

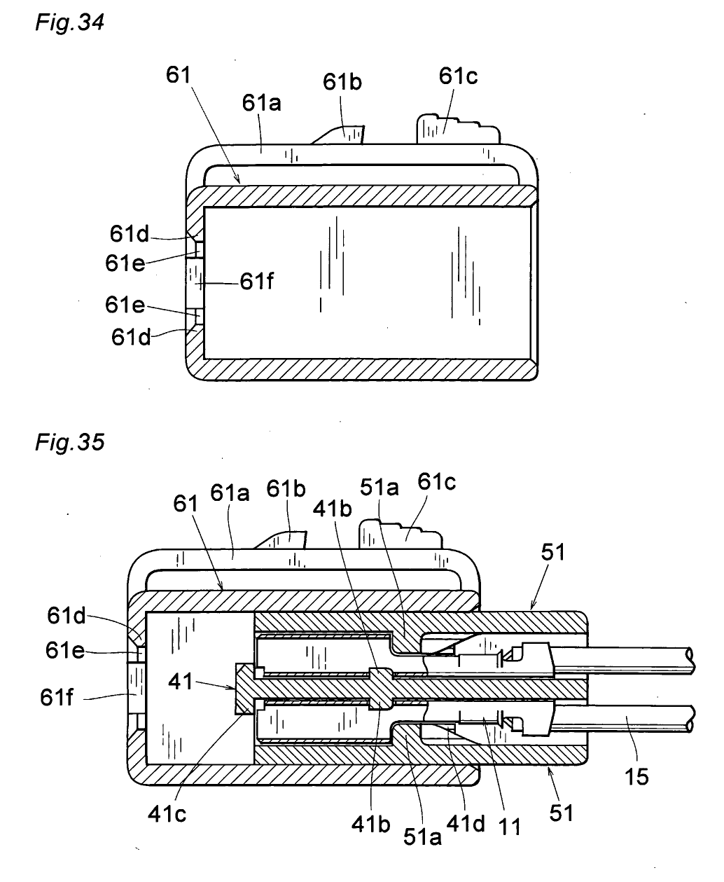

FIGS. 33 and 34 are a front view and a longitudinal cross sectional view, respectively showing the outer cover 61. The outer cover 61 has a vacant space, and a resilient bridge portion 61a, locking projection 61b and a push portion 61c are formed on an upper surface. A front wall portion 61d of the outer cover 61 has formed therein guide openings 61e and a fitting hole 61f into which a front end of the intermediate holder 41 is inserted.

After fixing the connection terminals 11 into the upper and lower grooves 41a of the intermediate holder 41, the intermediate holder 41 is covered with the intermediate upper cover 51. Then, an assembly of the intermediate holder 41 and intermediate upper cover 51 is inserted into the outer cover 61 as shown in FIG. 35 to obtain the electric connector housing shown in FIG. 32.

In this condition, the connection terminals 11 are prevented from moving in forward and backward direction by means of the intermediate holder 41, and moreover the backward movement of the connection terminals 11 is inhibited by the intermediate upper cover 51.

### Embodiment 6

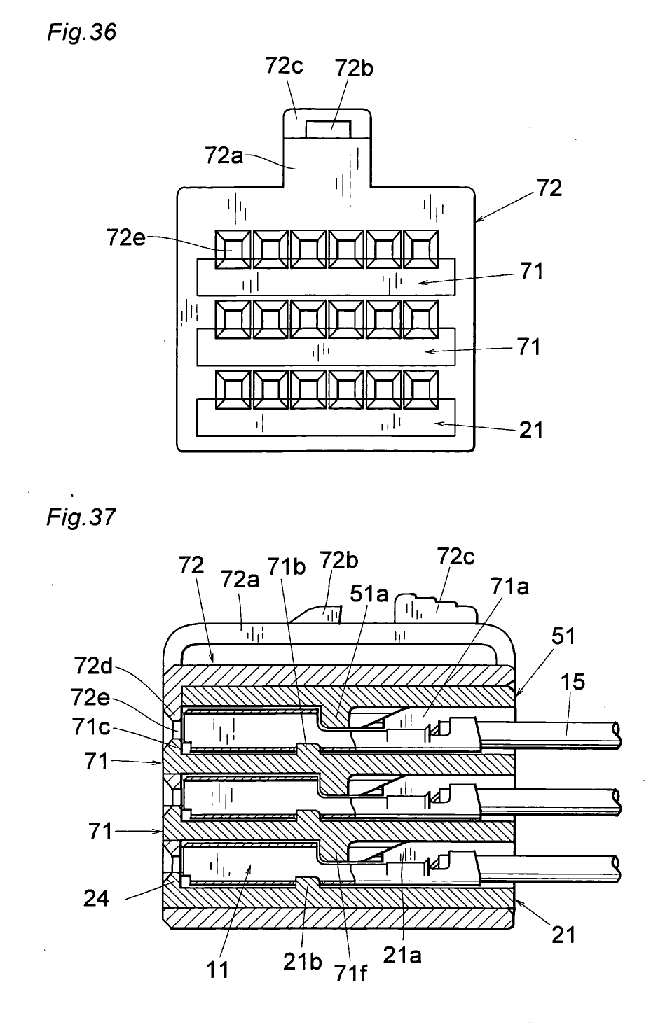

FIGS. 36 and 37 are a front view and a longitudinal cross sectional view, respectively showing the electric connector housing of the sixth embodiment 6. A plan view of the electric connector housing of this embodiment 6 is identical with that shown in FIG. 23. Two intermediate holders 71 are stacked on a holder 21 which is identical with that of the first embodiment 1, and an intermediate upper cover 51 which is identical with that of the fourth embodiment 4 is stacked on the upper intermediate holder 71. A plurality of connection terminals 11 are installed within the holder 21 and intermediate holders 71, and an assembly of the holder 21, intermediate holders 71 and intermediate upper cover 51 is covered with an outer cover 72.

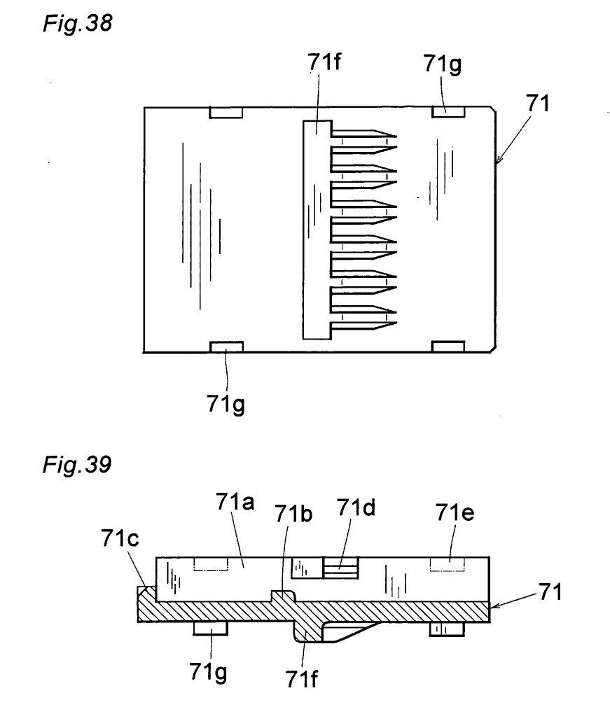

FIGS. 38 and 39 are a bottom view and a longitudinal cross sectional view, respectively showing the intermediate holder 71. A plan view of this intermediate holder 71 is identical with that shown in FIG. 7. On an upper surface of the intermediate holder 71 there are formed a plurality of grooves 71a, and in each of the grooves 71a there is formed an engaging protrusion 71b. The intermediate holder 71 has further formed therein a front wall portion 71c, projections 71d for inhibiting the up and down movement of the connection terminals and four locking recesses 71e at four corners. Furthermore, in the lower surface of the intermediate holder 71, there are formed a locking protection 71f and four locking claws 71g at four courners.

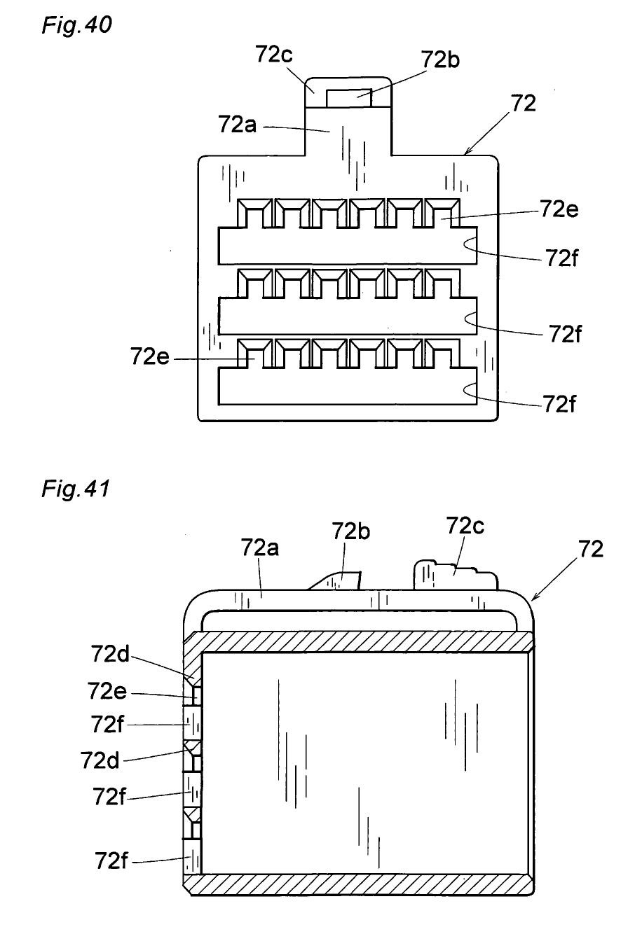

FIGS. 40 and 41 are a front view and a longitudinal cross sectional view, respectively depicting the outer cover 72. The outer cover 72 includes a resilient bridge portion 72a, a locking projection 72b and a push portion 72c. A front wall portion 72d of the outer cover 72 has formed therein guide openings 72e and fitting holes 72f into which front ends of the holder 21 and intermediate holders 71 are inserted.

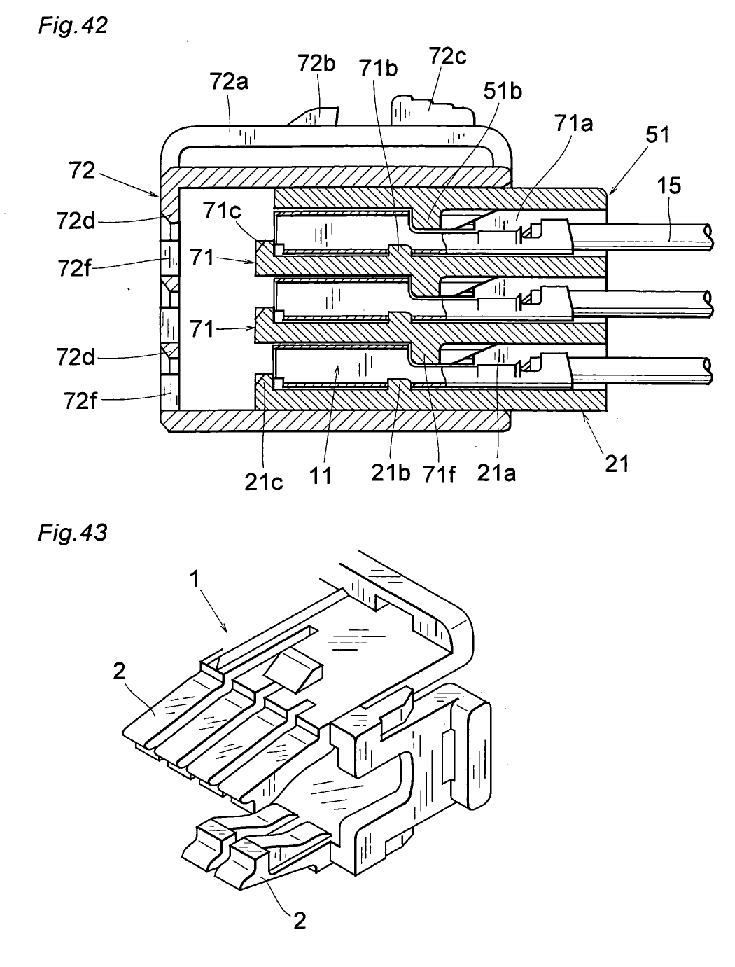

An assembly of the holder 21, intermediate holders 71 and intermediate upper cover 51 is inserted into the outer cover 72 as illustrated in FIG. 42 to obtain the electric connector housing shown in FIG. 37.

In this condition, the connection terminals 11 are prevented from moving in forward and backward directions by means of the holder 21 and intermediate holder 71, and the backward movement of the connection terminals 11 is inhibited by the intermediate upper cover 51.

### INDUSTRIAL APPLICABILITY

It should be noted that in the above explained embodiments, the electric connector housing is formed as a receipt type, but the present invention may be equally applied the electric connector housing of insertion type.

1. An electric connector housing comprising an assembly of a holder being opened upwardly and having a plurality of grooves for accommodating therein respective connection terminals and a cover for covering the holder, wherein movement preventing means for preventing said connection terminals from moving in forward and backward direction are provided in either one or both of said holder and cover.

2. The electric connector housing according to claim 1, wherein said holder has formed therein movement prohibiting means for prohibiting movement of said connection terminals in up and down direction.

3. The electric connector housing according to claim 1, wherein said plurality of grooves are formed in upper and lower surfaces of the holder such that the connection terminals are stacked in a multi-layer manner, and the upper and lower surfaces of the holder are covered with upper and lower covers, respectively.

4. The electric connector housing according to claim 1, wherein between said holder and cover, at least one intermediate holder is arranged, said at least one intermediate holder having a structure which is a combination of structures of said holder and cover.

5. The electric connector housing according to claim 3, further comprising locking means for fixing said stacked parts.

6. The electric connector housing according to claim 3, wherein the uppermost cover includes a locking means for locking a clamped condition of the electric connector housing with a cooperating electric connector housing.

7. The electric connector housing according to claim 1, further comprising an outer cover for covering an assembly of the holder and cover.

8. The electric connector housing according to claim 4, further comprising an outer cover for covering an assembly of the holder, cover and at least one intermediate holder.

9. The electric connector housing according to claim 8, wherein said outer cover includes a locking means for locking an engaged condition of the electric connector housing with a cooperating electric connector housing.

10. The electric connector housing according to claim 7, wherein said outer cover includes a locking means for locking an engaged condition of the electric connector housing with a cooperating electric connector housing.

11. The electric connector housing according to claim 2, wherein said plurality of grooves are formed in upper and lower surfaces of the holder such that the connection terminals are stacked in a multi-layer manner, and the upper and lower surfaces of the holder are covered with upper and lower covers, respectively.

12. The electric connector housing according to claim 2, wherein between said holder and cover, one intermediate holder is arranged, said at least one intermediate holder having a structure which is a combination of structures of said holder and cover.

13. The electric connector housing according to claim 2, further comprising an outer cover for covering an assembly of the holder and cover.

14. The electric connector housing according to claim 3, further comprising an outer cover for covering an assembly of the holder and cover.
